(19) United States
(12) Patent Application Publication
(10) Pub. No.: US 2014/0116695 A1
(43) Pub. Date: May 1, 2014

(54) EMULSIFIED ACID WITH HYDROPHOBIC NANOPARTICLES FOR WELL STIMULATION

(71) Applicant: HALLIBURTON ENERGY SERVICES, INC., Houston, TX (US)

(72) Inventors: Shadaab Syed Maghrabi, Thane (IN); Chaitanya M. Karale, Pune (IN)

(73) Assignee: HALLIBURTON ENERGY SERVICES, INC., Houston, TX (US)

(21) Appl. No.: 13/663,681

(22) Filed: Oct. 30, 2012

(51) Int. Cl. C09K 8/74; E21B 43/22

(52) U.S. Cl. 166/279; 507/240

(57) ABSTRACT

A composition in the form of an emulsion having: (i) a continuous oil phase comprising: (a) an oil; (b) an emulsifier; and (c) a particulate comprising an oxide selected from the group consisting of metal oxides, metalloid oxides, and any combination thereof, wherein the particulate is hydrophobically modified, would not dissolve in oil or 28% hydrochloric acid, and has a surface area in the range of 700 m²/g to 30 m²/g; and (ii) an internal aqueous phase comprising water having a pH of less than zero. A method of acidizing a treatment zone of a subterranean formation in a well includes the steps of: (A) forming a treatment fluid comprising such a composition; and (B) introducing the treatment fluid into a well, wherein the design temperature is at least 275° F. Preferably, the particulate is hydrophobically modified silica.

### CROSS-REFERENCE TO RELATED APPLICATIONS

Not applicable.

### TECHNICAL FIELD

The inventions are in the field of producing crude oil or natural gas from subterranean formations. More specifically, the inventions generally relate to methods acidizing a subterranean formation.

### BACKGROUND

To produce oil or gas, a well is drilled into a subterranean formation that is an oil or gas reservoir.

Drilling, completion, and intervention operations can include various types of treatments that are commonly performed in a wellbore or subterranean formation.

For example, a treatment for fluid-loss control can be used during any of drilling, completion, and intervention operations. During completion or intervention, stimulation is a type of treatment performed to enhance or restore the productivity of oil and gas from a well. Stimulation treatments fall into two main groups: hydraulic fracturing and matrix treatments. Fracturing treatments are performed above the fracture pressure of the subterranean formation to create or extend a highly permeable flow path between the formation and the wellbore. Matrix treatments are performed below the fracture pressure of the formation. Other types of completion or intervention treatments include, but are not limited to, damage removal, formation isolation, wellbore cleanout, scale removal, and scale control. Of course, other well treatments and treatment fluids are known in the art.

Carbonate Formations

Carbonate formations tend to have complex porosity and permeability variations and irregular fluid flow paths. Even small improvements in recovery methods can yield dramatic production results.

It is desirable to extend the production of wells in carbonate reservoirs and to avoid early abandonment when productivity decreases as a result of formation damage or low natural permeability. In clastic reservoirs, a range of stimulation techniques can be applied with a high degree of confidence to create conductive flow paths, primarily using hydraulic fracturing techniques as known in the field. Although many of these stimulation methods can also be applied in carbonate reservoirs, it may be difficult to predict effectiveness for increasing production.

Stimulation of carbonate formations usually involves a reaction between an acid and the minerals calcite (CaCO₃) or dolomite CaMg(CO₃)₂ that is intended to enhance the flow properties of the rock. In carbonate reservoirs, hydrochloric acid (HCl) is the most commonly applied stimulation fluid. Organic acids such as formic or acetic acid are used, mainly in retarded-acid systems or in high-temperature applications, to acidize either sandstones or carbonates. Stimulation of carbonate formations usually does not involve hydrofluoric acid, which is difficult to handle and commonly used in acidizing sandstone formations.

Acidizing

A widely used stimulation technique is acidizing, in which a treatment fluid including or forming an aqueous acid solution is introduced into the formation to dissolve acid-soluble materials. This can accomplish a number of purposes, which can be, for example, to help remove residual fluid material or filtercake damage or to increase the permeability of a treatment zone. In this way, hydrocarbon fluids can more easily flow from the formation into the well. In addition, an acid treatment can facilitate the flow of injected treatment fluids from the well into the formation. This procedure enhances production by increasing the effective well radius.

Acidizing techniques can be carried out as matrix acidizing procedures or as acid fracturing procedures. Matrix treatments are often applied in treatment zones having good natural permeability to counteract damage in the near-wellbore area. Fracturing treatments are often applied in treatment zones having poor natural permeability.

In matrix acidizing, an acidizing fluid is injected from the well into the formation at a rate and pressure below the pressure sufficient to create a fracture in the formation. In sandstone formations, the acid primarily removes or dissolves acid soluble damage in the near wellbore region and is thus classically considered a damage removal technique and not a stimulation technique. In carbonate formations, the goal is to actually a stimulation treatment where in the acid forms conducted channels called wormholes in the formation rock. Greater details, methodology, and exceptions can be found in “Production Enhancement with Acid Stimulation” 2^{nd} edition by Leonard Kalfayan (PennWell 2008), SPE 129329, SPE 123869, SPE 121464, SPE 121803, SPE 121008, IPTC 10693, 66564-PA, and the references contained therein.

In acid fracturing, an acidizing fluid is pumped into a carbonate formation at a sufficient pressure to cause fracturing of the formation and creating differential (non-uniform) etching fracture conductivity. Acid fracturing involves the formation of one or more fractures in the formation and the introduction of an aqueous acidizing fluid into the fractures to etch the fractures faces, whereby flow channels are formed when the fractures close. The aqueous acidizing fluid also enlarges the pore spaces in the fracture faces and in the formation. In acid fracturing treatments, one or more fractures are produced in the formation and the acidic solution is introduced into the fracture to etch flow channels in the fracture face. The acid also enlarges the pore spaces in the fracture face and in the formation. Greater details, methodology, and exceptions can be found in “Production Enhancement with Acid Stimulation” 2^{nd} edition by Leonard Kalfayan (PennWell 2008), SPE 129329, SPE 123869, SPE 121464, SPE 121803, SPE 121008, IPTC 10693, 66564-PA, and the references contained therein.

The use of the term “acidizing” herein refers to both matrix and fracturing types of acidizing treatments, and more specifically, refers to the general process of introducing an acid down hole to perform a desired function, e.g., to acidize a portion of a subterranean formation or any damage contained therein.

Problems with Using Acids in Well Fluids

Although acidizing a portion of a subterranean formation can be very beneficial in terms of permeability, conventional acidizing systems have significant drawbacks. One major problem associated with conventional acidizing treatment systems is that deeper penetration into the formation is not usually achievable because, inter alia, the acid may be spent before it can deeply penetrate into the subterranean formation. The rate at which acidizing fluids react with reactive materials in the subterranean formation is a function of various factors including, but not limited to, acid concentration, temperature, fluid velocity, mass transfer, and the type of reactive material encountered. Whatever the rate of reaction of the acidic solution, the solution can be introduced into the formation only a certain distance before it becomes spent. For instance, conventional acidizing fluids, such as those that contain organic acids, hydrochloric acid or a mixture of hydrofluoric and hydrochloric acids, have high acid strength and quickly react with the formation itself, fines and damage nearest the well bore, and do not penetrate the formation to a desirable degree before becoming spent. To achieve optimal results, it is desirable to maintain the acidic solution in a reactive condition for as long a period as possible to maximize the degree of penetration so that the permeability enhancement produced by the acidic solution may be increased.

Another problem associated with using acidic well fluids is the corrosion caused by the acidic solution to any metals (such as tubulars) in the well bore and the other equipment used to carry out the treatment. For instance, conventional acidizing fluids, such as those that contain organic acids, hydrochloric acid or a mixture of hydrofluoric and hydrochloric acids, have a tendency to corrode tubing, casing and down hole equipment, such as gravel pack screens and down hole pumps, especially at elevated temperatures. The expense of repairing or replacing corrosion-damaged equipment is extremely high. The corrosion problem is exacerbated by the elevated temperatures encountered in deeper formations. The increased corrosion rate of the ferrous and other metals comprising the tubular goods and other equipment results in quantities of the acidic solution being neutralized before it ever enters the subterranean formation, which can compound the deeper penetration problem discussed above. The partial neutralization of the acid results in the production of quantities of metal ions that are highly undesirable in the subterranean formation.

Acid in Oil Emulsions

Historically, water-in-oil emulsified acids have primarily been used in fracture acidizing. The emulsified state of the acid makes it diffuse at much slower rate, thereby retarding the chemical reaction rate with the formation. However, the stability of the emulsion becomes questionable as the fluid experiences high temperature of the formation (i.e., equal to or greater than 275° F.).

The corrosion inhibition for the tubulars of the well while pumping the acidizing fluid down hole to the treatment zone of a subterranean formation is always an issue.

In addition, the higher the temperature in the tubulars of the well and the higher the design temperature in the treatment zone of the subterranean formation, the greater the rate of corrosion, which increases the rate of damage to the tubulars.

Unfortunately, the compatibility of the corrosion inhibitor with the emulsifier in prior emulsified acidizing fluids is questionable, which significantly affects the temperature stability of emulsion.

The breaking of the emulsion before the targeted time can cause severe corrosion of the tubular.

Acid internal emulsions can be used to help separate the acid from the tubulars, but high concentrations of hydrochloric acid, a commonly used acid for acidizing, can be difficult to stabilize in an emulsion. Halliburton has used fumed silica in the aqueous phase of an emulsified acid system, however, this system and other systems do not provide emulsion stability at higher temperatures (i.e., greater than about 250° F.).

Therefore, among other needs, there is a need for acidizing treatment fluids and methods with acids for stimulation of carbonate formations at high temperatures (i.e., equal to or greater than 275° F.) while offering minimum protection against corrosion.

### SUMMARY OF THE INVENTION

According to an embodiment of the invention, a composition in the form of an emulsion is provided. The composition has: (i) a continuous oil phase comprising: (a) an oil; (b) an emulsifier; and (c) a particulate comprising an oxide selected from the group consisting of metal oxides, metalloid oxides, and any combination thereof, wherein the particulate is hydrophobically modified, would not dissolve in oil or 28% hydrochloric acid, and has a surface area in the range of 700 m²/g to 30 m²/g; and (ii) an internal aqueous phase comprising water having a pH of less than zero. Preferably, the particulate is hydrophobically modified silica.

According to another embodiment of the invention, a method of acidizing a treatment zone of a subterranean formation in a well is provided. The method includes the steps of: (A) forming a treatment fluid comprising a composition according to the invention; and (B) introducing the treatment fluid into a well, wherein the design temperature is at least 275° F.

These and other aspects of the invention will be apparent to one skilled in the art upon reading the following detailed description. While the invention is susceptible to various modifications and alternative forms, specific embodiments thereof will be described in detail and shown by way of example. It should be understood, however, that it is not intended to limit the invention to the particular forms disclosed, but, on the contrary, the invention is to cover all modifications and alternatives falling within the spirit and scope of the invention as expressed in the appended claims.

### DETAILED DESCRIPTION OF PRESENTLY PREFERRED EMBODIMENTS

### Definitions and Usages

Interpretation

The words or terms used herein have their plain, ordinary meaning in the field of this disclosure, except to the extent explicitly and clearly defined in this disclosure.

If there is any conflict in the usages of a word or term in this disclosure and one or more patent(s) or other documents that may be incorporated by reference, the definitions that are consistent with this specification should be adopted.

The words “comprising,” “containing,” “including,” “having,” and all grammatical variations thereof are intended to have an open, non-limiting meaning. For example, a composition comprising a component does not exclude it from having additional components, an apparatus comprising a part does not exclude it from having additional parts, and a method having a step does not exclude it having additional steps. When such terms are used, the compositions, apparatuses, and methods that “consist essentially of” or “consist of” the specified components, parts, and steps are specifically included and disclosed.

The indefinite articles “a” or “an” mean one or more than one of the component, part, or step that the article introduces.

Whenever a numerical range of degree or measurement with a lower limit and an upper limit is disclosed, any number and any range falling within the range is also intended to be specifically disclosed. For example, every range of values (in the form “from a to b,” or “from about a to about b,” or “from about a to b,” “from approximately a to b,” and any similar expressions, where “a” and “b” represent numerical values of degree or measurement) is to be understood to set forth every number and range encompassed within the broader range of values.

Oil and Gas Reservoirs

In the context of production from a well, oil and gas are understood to refer to crude oil and natural gas. Oil and gas are naturally occurring hydrocarbons in certain subterranean formations.

A “subterranean formation” is a body of rock that has sufficiently distinctive characteristics and is sufficiently continuous for geologists to describe, map, and name it. A subterranean formation having a sufficient porosity and permeability to store and transmit fluids is sometimes referred to as a “reservoir.” A subterranean formation containing oil or gas may be located under land or under the seabed off shore. Oil and gas reservoirs are typically located in the range of a few hundred feet (shallow reservoirs) to a few tens of thousands of feet (ultra-deep reservoirs) below the surface of the land or seabed.

Carbonate, Sandstone, and Other Formations

Reservoirs can be of various rock materials.

As used herein, a subterranean formation having greater than about 50% by weight of inorganic carbonate materials (e.g., limestone or dolomite) is referred to as a “carbonate formation.”

As used herein, a subterranean formation having greater than about 50% by weight of inorganic silicatious materials (e.g., sandstone) is referred to as a “sandstone formation.”

Well Terms

A “well” includes a wellhead and at least one wellbore from the wellhead penetrating the earth. The “wellhead” is the surface termination of a wellbore, which surface may be on land or on a seabed. A “well site” is the geographical location of a wellhead of a well. It may include related facilities, such as a tank battery, separators, compressor stations, heating or other equipment, and fluid pits. If offshore, a well site can include a platform.

The “wellbore” refers to the drilled hole, including any cased or uncased portions of the well. The “borehole” usually refers to the inside wellbore wall, that is, the rock face or wall that bounds the drilled hole. A wellbore can have portions that are vertical, horizontal, or anything in between, and it can have portions that are straight, curved, or branched. As used herein, “uphole,” “downhole,” and similar terms are relative to the direction of the wellhead, regardless of whether a wellbore portion is vertical or horizontal.

As used herein, introducing “into a well” means introduced at least into and through the wellhead. According to various techniques known in the art, tubulars, equipment, tools, or well fluids can be directed from the wellhead into any desired portion of the wellbore.

As used herein, the word “tubular” means any kind of body in the form of a tube. Examples of tubulars include, but are not limited to, a drill pipe, a casing, a tubing string, a line pipe, and a transportation pipe. Tubulars can also be used to transport fluids into or out of a subterranean formation, such as oil, gas, water, liquefied methane, coolants, and heated fluids. For example, a tubular can be placed underground to transport produced hydrocarbons or water from a subterranean formation to another location.

As used herein, a “well fluid” broadly refers to any fluid adapted to be introduced into a well for any purpose. A well fluid can be, for example, a drilling fluid, a cementing composition, a treatment fluid, or a spacer fluid. If a well fluid is to be used in a relatively small volume, for example less than about 200 barrels (32 m³), it is sometimes referred to as a wash, dump, slug, or pill.

As used herein, the word “treatment” refers to any treatment for changing a condition of a portion of a wellbore or an adjacent subterranean formation; however, the word “treatment” does not necessarily imply any particular treatment purpose. A treatment usually involves introducing a well fluid for the treatment, in which case it may be referred to as a treatment fluid, into a well. As used herein, a “treatment fluid” is a fluid used in a treatment. Unless the context otherwise requires, the word “treatment” in the term “treatment fluid” does not necessarily imply any particular treatment or action by the fluid.

A zone refers to an interval of rock along a wellbore that is differentiated from uphole and downhole zones based on hydrocarbon content or other features, such as permeability, composition, perforations or other fluid communication with the wellbore, faults, or fractures. A zone of a wellbore that penetrates a hydrocarbon-bearing zone that is capable of producing hydrocarbon is referred to as a “production zone.” A “treatment zone” refers to an interval of rock along a wellbore into which a well fluid is directed to flow from the wellbore. As used herein, “into a treatment zone” means into and through the wellhead and, additionally, through the wellbore and into the treatment zone.

The term “damage” as used herein refers to undesirable deposits in a subterranean formation that may reduce its permeability. Scale, skin, gel residue, and hydrates are contemplated by this term. Also contemplated by this term are geological deposits, such as, but not limited to, carbonates located on the pore throats of the sandstone in a subterranean formation.

As used herein, a downhole fluid is an in-situ fluid in a well, which may be the same as a well fluid at the time it is introduced, or a well fluid mixed with another other fluid downhole, or a fluid in which chemical reactions are occurring or have occurred in-situ downhole.

Generally, the greater the depth of the formation, the higher the static temperature and pressure of the formation. Initially, the static pressure equals the initial pressure in the formation before production. After production begins, the static pressure approaches the average reservoir pressure.

A “design” refers to the estimate or measure of one or more parameters planned or expected for a particular well fluid or stage of a well service. A well service may include design parameters such as fluid volume to be pumped, required pumping time for a treatment, or the shear conditions of the pumping.

The term “design temperature” refers to an estimate or measurement of the actual temperature at the downhole environment at the time of a well treatment. That is, design temperature takes into account not only the bottom hole static temperature (“BHST”), but also the effect of the temperature of the well fluid on the BHST during treatment. The design temperature is sometimes referred to as the bottom hole circulation temperature (“BHCT”). Because treatment fluids may be considerably cooler than BHST, the difference between the two temperatures can be quite large. Ultimately, if left undisturbed, a subterranean formation will return to the BHST.

Physical States and Phases

The common physical states of matter include solid, liquid, and gas. A solid has a fixed shape and volume, a liquid has a fixed volume and conforms to the shape of a container, and a gas disperses and conforms to the shape of a container. Distinctions among these physical states are based on differences in intermolecular attractions. Solid is the state in which intermolecular attractions keep the molecules in fixed spatial relationships. Liquid is the state in which intermolecular attractions keep molecules in proximity (low tendency to disperse), but do not keep the molecules in fixed relationships. Gas is that state in which the molecules are comparatively separated and intermolecular attractions have relatively little effect on their respective motions (high tendency to disperse).

As used herein, “phase” is used to refer to a substance having a chemical composition and physical state that is distinguishable from an adjacent phase of a substance having a different chemical composition or different physical state.

As used herein, if not other otherwise specifically stated, the physical state or phase of a substance (or mixture of substances) and other physical properties are determined at a temperature of 77° F. (25° C.) and a pressure of 1 atmosphere (Standard Laboratory Conditions) without applied shear.

Particles and Particulates

As used herein, unless the context otherwise requires, a “particle” refers to a body having a finite mass and sufficient cohesion such that it can be considered as an entity but having relatively small dimensions. A particle can be of any size ranging from molecular scale to macroscopic, depending on context.

A particle can be in any physical state. For example, a particle of a substance in a solid state can be as small as a few molecules on the scale of nanometers up to a large particle on the scale of a few millimeters, such as large grains of sand. Similarly, a particle of a substance in a liquid state can be as small as a few molecules on the scale of nanometers or a large drop on the scale of a few millimeters. A particle of a substance in a gas state is a single atom or molecule that is separated from other atoms or molecules such that intermolecular attractions have relatively little effect on their respective motions.

As used herein, “particulate” or “particulate material” refers to matter in the physical form of distinct particles in a solid or liquid state (which means such an association of a few atoms or molecules). A particulate is a grouping of particles based on common characteristics, including chemical composition and particle size range, particle size distribution, or median particle size. As used herein, a particulate is a grouping of particles having similar chemical composition and particle size ranges.

A particulate can be of solid or liquid particles. As used herein, however, unless the context otherwise requires, particulate refers to a solid particulate. Of course, a solid particulate is a particulate of particles that are in the solid physical state, that is, the constituent atoms, ions, or molecules are sufficiently restricted in their relative movement to result in a fixed shape for each of the particles.

The term “particulate” as used herein is intended to include material particles having the physical shape of platelets, shavings, flakes, ribbons, rods, strips, spheroids, toroids, pellets, tablets or any other physical shape.

If not otherwise stated, a reference to a single particle size means about the mid-point of the industry-accepted size range for the particulate.

The most commonly-used grade scale for classifying the diameters of sediments in geology is the Udden-Wentworth scale. According to this scale, a solid particulate having particles smaller than 2 mm in diameter is classified as sand, silt, or clay. Sand is a detrital grain between 2 mm (equivalent to 2,000 micrometers) and 0.0625 mm (equivalent to 62.5 micrometers) in diameter. (Sand is also a term sometimes used to refer to quartz grains or for sandstone.) Silt refers to particulate between 74 micrometers (equivalent to about −200 U.S. Standard mesh) and about 2 micrometers. Clay is a particulate smaller than 0.0039 mm (equivalent to 3.9 μm).

Dispersions

A dispersion is a system in which particles of a substance of one chemical composition and physical state are dispersed in another substance of a different chemical composition or physical state. In addition, phases can be nested. If a substance has more than one phase, the most external phase is referred to as the continuous phase of the substance as a whole, regardless of the number of different internal phases or nested phases.

A dispersion can be classified a number of different ways, including based on the size of the dispersed particles, the uniformity or lack of uniformity of the dispersion, and, if a fluid, whether or not precipitation occurs.

A dispersion is considered to be heterogeneous if the dispersed particles are not dissolved and are greater than about 1 nanometer in size. (For reference, the diameter of a molecule of toluene is about 1 nm).

Heterogeneous dispersions can have gas, liquid, or solid as an external phase. For example, in a case where the dispersed-phase particles are liquid in an external phase that is another liquid, this kind of heterogeneous dispersion is more particularly referred to as an emulsion. A solid dispersed phase in a continuous liquid phase is referred to as a sol, suspension, or slurry, partly depending on the size of the dispersed solid particulate.

A dispersion is considered to be homogeneous if the dispersed particles are dissolved in solution or the particles are less than about 1 nanometer in size. Even if not dissolved, a dispersion is considered to be homogeneous if the dispersed particles are less than about 1 nanometer in size.

Heterogeneous dispersions can be further classified based on the dispersed particle size.

A heterogeneous dispersion is a “suspension” where the dispersed particles are larger than about 50 micrometer. Such particles can be seen with a microscope, or if larger than about 50 micrometers (0.05 mm), with the unaided human eye. The dispersed particles of a suspension in a liquid external phase may eventually separate on standing, e.g., settle in cases where the particles have a higher density than the liquid phase. Suspensions having a liquid external phase are essentially unstable from a thermodynamic point of view; however, they can be kinetically stable over a long period depending on temperature and other conditions.

A heterogeneous dispersion is a “colloid” where the dispersed particles range up to about 50 micrometer (50,000 nanometers) in size. The dispersed particles of a colloid are so small that they settle extremely slowly, if ever. In some cases, a colloid can be considered as a homogeneous mixture. This is because the distinction between “dissolved” and “particulate” matter can be sometimes a matter of approach, which affects whether or not it is homogeneous or heterogeneous.

Homogeneous Dispersions: Solutions and Solubility

A solution is a special type of homogeneous mixture. A solution is considered homogeneous: (a) because the ratio of solute to solvent is the same throughout the solution; and (b) because solute will never settle out of solution, even under powerful centrifugation, which is due to intermolecular attraction between the solvent and the solute. An aqueous solution, for example, saltwater, is a homogenous solution in which water is the solvent and salt is the solute.

One may also refer to the solvated state, in which a solute ion or molecule is complexed by solvent molecules. A chemical that is dissolved in solution is in a solvated state. The solvated state is distinct from dissolution and solubility. Dissolution is a kinetic process, and is quantified by its rate. Solubility quantifies the concentration of the solute at which there is dynamic equilibrium between the rate of dissolution and the rate of precipitation of the solute. Dissolution and solubility can be dependent on temperature and pressure, and may be dependent on other factors, such as salinity or pH of an aqueous phase.

A substance is considered to be “soluble” in a liquid if at least 10 grams of the substance can be dissolved in one liter of the liquid when tested at 77° F. and 1 atmosphere pressure for 2 hours and considered to be “insoluble” if less soluble than this.

As will be appreciated by a person of skill in the art, the hydratability, dispersibility, or solubility of a substance in water can be dependent on the salinity, pH, or other substances in the water. Accordingly, the salinity, pH, and additive selection of the water can be modified to facilitate the hydratability, dispersibility, or solubility of a substance in aqueous solution. To the extent not specified, the hydratability, dispersibility, or solubility of a substance in water is determined in deionized water, at neutral pH, and without any other additives.

The “source” of a chemical species in a solution or fluid composition, can be a substance that makes the chemical species chemically available immediately or it can be a substance that gradually or later releases the chemical species to become chemically available.

Fluids

A fluid can be a single phase or a dispersion. In general, a fluid is an amorphous substance that is or has a continuous phase of particles that are smaller than about 1 micrometer that tends to flow and to conform to the outline of its container.

Examples of fluids are gases and liquids. A gas (in the sense of a physical state) refers to an amorphous substance that has a high tendency to disperse (at the molecular level) and a relatively high compressibility. A liquid refers to an amorphous substance that has little tendency to disperse (at the molecular level) and relatively high incompressibility. The tendency to disperse is related to Intermolecular Forces (also known as van der Waal's Forces). (A continuous mass of a particulate, e.g., a powder or sand, can tend to flow as a fluid depending on many factors such as particle size distribution, particle shape distribution, the proportion and nature of any wetting liquid or other surface coating on the particles, and many other variables. Nevertheless, as used herein, a fluid does not refer to a continuous mass of particulate as the sizes of the solid particles of a mass of a particulate are too large to be appreciably affected by the range of Intermolecular Forces.)

As used herein, a fluid is a substance that behaves as a fluid under Standard Laboratory Conditions, that is, at 77° F. (25° C.) temperature and 1 atmosphere pressure, and at the higher temperatures and pressures usually occurring in subterranean formations without applied shear.

Every fluid inherently has at least a continuous phase. A fluid can have more than one phase. The continuous phase of a well fluid is a liquid under Standard Laboratory Conditions. For example, a well fluid can in the form of be a suspension (solid particles dispersed in a liquid phase), an emulsion (liquid particles dispersed in another liquid phase), or a foam (a gas phase dispersed in liquid phase).

As used herein, a water-based fluid means that water or an aqueous solution is the dominant material, that is, greater than 50% by weight, of the continuous phase of the substance.

In contrast, “oil-based” means that oil is the dominant material by weight of the continuous phase of the substance. In this context, the oil of an oil-based fluid can be any oil. In general, an oil is any substance that is liquid Standard Laboratory Conditions, is hydrophobic, and soluble in organic solvents. Oils have a high carbon and hydrogen content and are relatively non-polar substances, for example, having a polarity of 3 or less on the Synder polarity index. This general definition includes classes such as petrochemical oils, vegetable oils, and many organic solvents. All oils can be traced back to organic sources.

General Measurement Terms

Unless otherwise specified or unless the context otherwise clearly requires, any ratio or percentage means by weight.

Unless otherwise specified or unless the context otherwise clearly requires, the phrase “by weight of the water” means the weight of the water of the continuous phase of the fluid without the weight of any viscosity-increasing agent, dissolved salt, suspended particulate, or other materials or additives that may be present in the water.

Any doubt regarding whether units are in U.S. or Imperial units, where there is any difference, U.S. units are intended. For example, “gal/Mgal” means U.S. gallons per thousand U.S. gallons (“GPT”).

General Composition and Method

Halliburton's Carbonate Emulsified Acid (CEA) is a very good, non-damaging acid blend for carbonate acidizing. However, this blend uses 22% HCl acid and not 28% HCl acid. There is a strong demand for the ability to use emulsified hydrochloric acid at higher concentration, preferably up to about 28% HCl acid. Achieving acceptable corrosion loss and a stable emulsion at the same time is crucial for a successful emulsified acid blend.

However, we had very limited information and experimental data on applicability of this blend at temperatures greater than 250° F. One frequently experienced phenomenon was that increasing the amount of corrosion inhibitors decreases the stability of emulsified acids. With increasing temperature, the dosage requirement of corrosion inhibitors increases. This, in turn, contributes to instability of emulsions at such temperatures.

In general, the invention provides a treatment fluid in the form of an emulsion, which can be used for acid stimulation of a well. The fluid system has particular applicability in emulsified acid treatment using retarded acids. Such a system can be particularly useful for treating a zone of a carbonate formation. Such a system is adapted to provide improved stability at high temperatures (i.e., at least 275° F.).

A composition in the form of an emulsion is adapted to help physically separate the acid from metals in the well, such as the tubulars. The water with the acid is carried into the well and through the tubulars to the treatment zone as the internal phase of an external oil phase.

In addition, chemical corrosion inhibitors and corrosion inhibitor intensifiers can be included to help reduce the corrosion of the metal goods in the well. This is especially desirable at high temperatures because the rate of acid corrosion increases with increasing temperature.

It has been a common observation that when an emulsion breaks during a corrosion test, the corrosion loss was high, far above 0.05 lb/ft². As the metal is directly exposed to weakly inhibited acid after the destabilization of emulsion, it is more quickly corroded.

However, the stability of such emulsions can be a problem, especially with high concentrations of strong acid in the internal water phase and at high temperatures. Without being limited by any theory, there are several theoretical bases for the lack of stability, ranging from the very different densities of the water and oil phases to chemical reactivity of a strong acid in the water phase. Among other factors and problems, it is believed that there is a problem with the compatibility of emulsifiers with chemical corrosion inhibitors, especially at higher temperatures. This can be a particular challenge at higher temperatures (greater than 250° F.) and with high concentrations of HCl acid, especially at about 24% or more.

The emulsifier is a critical factor in the stability of an emulsified acid treatment fluid. In addition, one or more corrosion inhibitors are also highly valuable components in any acid blend, and generally considered necessary components, but are considered to be the most damaging to the emulsifier performance as they are believed to contribute to destabilizing the emulsion.

According to the invention, a treatment fluid includes a water-in-oil emulsion stabilized with a hydrophobic particulate.

According to an embodiment of the invention, a composition in the form of an emulsion is provided. The composition has: (i) a continuous oil phase comprising: (a) an oil; (b) an emulsifier; and (c) a particulate comprising an oxide selected from the group consisting of metal oxides, metalloid oxides, and any combination thereof, wherein the particulate is hydrophobically modified, would not dissolve in oil or 28% hydrochloric acid, and has a surface area in the range of 700 m²/g to 30 m²/g; and (ii) an internal aqueous phase comprising water having a pH of less than zero. In a preferred embodiment, the particulate would not dissolve in 35% hydrochloric acid.

According to another embodiment of the invention, a method of acidizing a treatment zone of a subterranean formation in a well is provided. The method includes the steps of: (A) forming a treatment fluid comprising a composition according to the invention; and (B) introducing the treatment fluid into a well, wherein the design temperature is at least 275° F.

The external phase of the composition for the treatment fluid consists of a hydrophobically modified silica nano-sized particulate that provides enhanced stability to the emulsion, thereby extending the use of the current emulsified acid systems at high temperatures and for long durations. The enhanced stability of the emulsion in turn provides improved corrosion control of the metal. Furthermore, without being limited by any theory, the hydrophobic nature of the modified silica particulate makes it to tend to stay near the metal surfaces of the tubulars, which is believed to provide additional corrosion inhibition. A hydrophobically modified silica in the oil phase of the emulsion is playing a crucial role in extending the application temperature and duration of the emulsified acid.

The improved stability of the emulsion and the slower diffusion of acid from the internal phase of the acidizing fluid is believed to improve the stimulation performance, especially in a carbonate formation.

The invert emulsion based fluid system is designed for efficient acid stimulation treatment of a subterranean formation. The emulsified acid system along with the hydrophobically-modified silica shows excellent stabilizing properties particularly at high temperatures. Additionally, the increased viscosity of the system as well as the presence of the hydrophobically-modified silica in the external oil phase may also contribute in reducing the diffusion rate of the acid, which is believed to provide a more retarded acid reaction in the subterranean formation. Furthermore, the hydrophobic particulate helps in stabilizing the emulsion in cases where it is difficult to get a stable emulsion with a high concentration of the corrosion inhibitor and emulsifier at high temperatures such as 275° F. for 4 hours using high concentration of HCl acid above about 24% by weight of the water. In addition, since the hydrophobically-modified silica is in the oil phase, it is believed to form a layer on a metal surface that provides additional protection against the acid coming into contact with the metal surfaces of the tubulars in the well, thus also helping to inhibit corrosion.

In an embodiment, the emulsified acid comprises an emulsifier and hydrophobic fumed silica in the oil external phase and hydrochloric acid, corrosion inhibitor, and inhibitor intensifier in the aqueous internal phase. This results in a more stable emulsified acid system. Without being limited by any theory, it is believed that the hydrophobically modified silica nano particulate is attracted at the acid-oil droplet interface. Therefore, it might also result more retarded acid reaction and better performance in terms of stimulation. It is also believed that the hydrophobic fumed silica in the oil phase is also easily adsorbed onto a metal surface, which may also provide additional corrosion inhibition as well. Furthermore, the emulsion can be broken by reacting with carbonate formation.

As per lab test results, the new formulation of emulsified acid system (with 28% HCl) was stable even at 300° F. and corrosion loss after 2 hour was 0.044 lb/ft². No existing Halliburton emulsified acid system with 28% HCl could provide a corrosion loss of less than 0.05 lb/ft². It is believed the acid system is stable at temperatures above 300° F.

This system is believed to be more retarded than the current emulsified acid (without silica), although we have not measured how much. The primary goal behind using emulsified acid is that it will react slowly with the carbonates compared to plain acid particularly at high temperatures. The more retarded release of the acid will allow use of acid system at much higher temperature (i.e., better performance at higher temperature).

Emulsion

An emulsion is a fluid including a dispersion of immiscible liquid particles in an external liquid phase. In addition, the proportion of the external and internal phases is above the solubility of either in the other.

An emulsion can be an oil-in-water (o/w) type or water-in-oil (w/o) type. A water-in-oil emulsion is sometimes referred to as an invert emulsion. In the context of an emulsion, a “water phase” refers to a phase of water or an aqueous solution and an “oil phase” refers to a phase of any non-polar organic liquid that is immiscible with water, such as petroleum, kerosene, or synthetic oil.

It should be understood that multiple emulsions are possible. These are sometimes referred to as nested emulsions. Multiple emulsions are complex polydispersed systems where both oil-in-water and water-in-oil emulsions exist simultaneously in the fluid, wherein the oil-in-water emulsion is stabilized by a lipophilic surfactant and the water-in-oil emulsion is stabilized by a hydrophilic surfactant. These include water-in-oil-in-water (w/o/w) and oil-in-water-in-oil (o/w/o) type multiple emulsions. Even more complex polydispersed systems are possible. Multiple emulsions can be formed, for example, by dispersing a water-in-oil emulsion in water or an aqueous solution, or by dispersing an oil-in-water emulsion in oil.

A stable emulsion is an emulsion that will not cream, flocculate, or coalesce under certain conditions, including time and temperature. As used herein, the term “cream” means at least some of the droplets of a dispersed phase converge towards the surface or bottom of the emulsion (depending on the relative densities of the liquids making up the continuous and dispersed phases). The converged droplets maintain a discrete droplet form. As used herein, the term “flocculate” means at least some of the droplets of a dispersed phase combine to form small aggregates in the emulsion. As used herein, the term “coalesce” means at least some of the droplets of a dispersed phase combine to form larger drops in the emulsion.

As used herein, to “break,” in regard to an emulsion, means to cause the creaming and coalescence of emulsified drops of the internal dispersed phase so that the internal phase separates out of the external phase. Breaking an emulsion can be accomplished mechanically (for example, in settlers, cyclones, or centrifuges), or via dilution, or with chemical additive to increase the surface tension of the internal droplets.

Preferably, an emulsion should be stable under one or more of certain conditions commonly encountered in the storage and use of such an emulsion composition for a well treatment operation. It should be understood that the dispersion is visually examined for creaming, flocculating, or coalescing.

Oil Phase

In a preferred embodiment of the invention, the oil of the oil phase is selected from the group consisting of petroleum, kerosene, or synthetic oil. An example of a synthetic oil is a long-chain alkane.

Emulsifier

Surfactants are compounds that lower the surface tension of a liquid, the interfacial tension between two liquids, or that between a liquid and a solid. Surfactants may act as detergents, wetting agents, emulsifiers, foaming agents, and dispersants.

Surfactants are usually organic compounds that are amphiphilic, meaning they contain both hydrophobic groups (“tails”) and hydrophilic groups (“heads”). Therefore, a surfactant contains both a water-insoluble (or oil soluble) portion and a water soluble portion.

In a water phase, surfactants form aggregates, such as micelles, where the hydrophobic tails form the core of the aggregate and the hydrophilic heads are in contact with the surrounding liquid. Other types of aggregates such as spherical or cylindrical micelles or bilayers can be formed. The shape of the aggregates depends on the chemical structure of the surfactants, depending on the balance of the sizes of the hydrophobic tail and hydrophilic head.

As used herein, the term micelle includes any structure that minimizes the contact between the lyophobic (“solvent-repelling”) portion of a surfactant molecule and the solvent, for example, by aggregating the surfactant molecules into structures such as spheres, cylinders, or sheets, wherein the lyophobic portions are on the interior of the aggregate structure and the lyophilic (“solvent-attracting”) portions are on the exterior of the structure. Micelles can function, among other purposes, to stabilize emulsions, break emulsions, stabilize a foam, change the wettability of a surface, solubilize certain materials, or reduce surface tension.

As used herein, an “emulsifier” refers to a type of surfactant that helps prevent the droplets of the dispersed phase of an emulsion from flocculating or coalescing in the emulsion. As used herein, an emulsifier refers to a chemical or mixture of chemicals that helps prevent the droplets of the dispersed phase of an emulsion from flocculating or coalescing in the emulsion. As used herein, an “emulsifier” or “emulsifying agent” does not mean or include a hydrophobic particulate.

An emulsifier can be or include a cationic, a zwitterionic, or a nonionic emulsifier. A surfactant package can include one or more different chemical surfactants.

The hydrophilic-lipophilic balance (“HLB”) of a surfactant is a measure of the degree to which it is hydrophilic or lipophilic, determined by calculating values for the different regions of the molecule, as described by Griffin in 1949 and 1954. Other methods have been suggested, notably in 1957 by Davies.)

In general, Griffin's method for non-ionic surfactants as described in 1954 works as follows:

HLB=20*Mh/M

where Mh is the molecular mass of the hydrophilic portion of the molecule, and M is the molecular mass of the whole molecule, giving a result on a scale of 0 to 20. An HLB value of 0 corresponds to a completely lipidphilic/hydrophobic molecule, and a value of 20 corresponds to a completely hydrophilic/lypidphobic molecule. Griffin W C: “Classification of Surface-Active Agents by ‘HLB,’” Journal of the Society of Cosmetic Chemists 1 (1949): 311. Griffin W C: “Calculation of HLB Values of Non-Ionic Surfactants,” Journal of the Society of Cosmetic Chemists 5 (1954): 249.

The HLB (Griffin) value can be used to predict the surfactant properties of a molecule, where a value less than 10 indicates that the surfactant molecule is lipid soluble (and water insoluble), whereas a value greater than 10 indicates that the surfactant molecule is water soluble (and lipid insoluble).

In 1957, Davies suggested an extended HLB method based on calculating a value based on the chemical groups of the molecule. The advantage of this method is that it takes into account the effect of stronger and weaker hydrophilic groups. The method works as follows:

HLB=7+m*Hh−n*Hl

where m is the number of hydrophilic groups in the molecule, Hh is the respective group HLB value of the hydrophilic groups, n is the number of lipophilic groups in the molecule, and Hl is the respective HLB value of the lipophilic groups. The specific values for the hydrophilic and hydrophobic groups are published. See, e.g., Davies J T: “A quantitative kinetic theory of emulsion type, I. Physical chemistry of the emulsifying agent,” Gas/Liquid and Liquid/Liquid Interface. Proceedings of the International Congress of Surface Activity (1957): 426-438.

The HLB (Davies) model can be used for applications including emulsification, detergency, solubilization, and other applications. Typically a HLB (Davies) value will indicate the surfactant properties, where a value of 1 to 3 indicates anti-foaming of aqueous systems, a value of 3 to 7 indicates W/O emulsification, a value of 7 to 9 indicates wetting, a value of 8 to 28 indicates O/W emulsification, a value of 11 to 18 indicates solubilization, and a value of 12 to 15 indicates detergency and cleaning.

In an embodiment, the emulsifier is an water-in-oil emulsifier according to the HBL (Davies) scale, that is, having an HLB (Davies) in the range of about 3 to about 7.

According to a preferred embodiment of the invention, the emulsifier is a cationic amine. Preferably, the cationic amine is a fatty cationic amine having more than 12 carbon atoms.

In an embodiment, the emulsifier is preferably in a concentration of at least 1% by weight of the emulsion. More preferably, the emulsifier is in a concentration in the range of 1% to 10% by weight of the emulsion.

Hydrophobic NanoParticulate

According to the invention, the emulsion includes a particulate comprising an oxide selected from the group consisting of metal oxides, metalloid oxides, and any combination thereof, wherein the particulate is hydrophobically modified, would not dissolve in oil or 28% hydrochloric acid, and has a surface area in the range of 700 m²/g to 30 m²/g. In a preferred embodiment, the particulate would not dissolve in 35% hydrochloric acid.

It should be understood that it is not necessary that the treatment fluid include hydrochloric acid, however, as this is merely a test for the chemical and solid stability of the hydrophobic particulate in any acidic fluid according to the invention, which may include such a strong acid in the internal phase of the emulsion.

As the particulate is nano-sized and hydrophobic, but insoluble in oil, the particulate can be dispersed in oil to form a colloid.

According to a preferred embodiment of the invention, the hydrophobic particulate is in a concentration of at least 0.1% by weight of the emulsion. The hydrophobic particulate is at least initially dispersed in the oil phase. In an embodiment, the hydrophobic particulate is in a concentration in the range of about 0.1% by weight to about 10% by weight of the emulsion. In another embodiment, the concentration of the hydrophobic particulate is effective to improve the stability of the emulsified acid as contrasted with an identical emulsified acid absent the hydrophobic particulate.

The hydrophobic particulate is preferably placed in the oil phase of the emulsion. Without being limited by any theory, it is believed the hydrophobic nano-sized particulate is attracted to the oil-water interface of the emulsion and helps stabilize the emulsion.

Nanoparticles are normally considered to be particles having one or more dimensions of the order of 100 nm or less. The particulate size of a nanoparticulate is believed to be related to the surface area by weight of the particulate, which can be measured, for example, according to the BET method as known in the field. BET theory aims to explain the physical adsorption of gas molecules on a solid surface and serves as the basis for an important analysis technique for the measurement of the specific surface area of a material. Stephen Brunauer, Paul Hugh Emmett, and Edward Teller, J. Am. Chem. Soc., 1938, 60, 309. “BET” is the first initials of their family names. The BET method is widely used in surface science for the calculation of surface areas of solids by physical adsorption of gas molecules. A surface area in the range of 700 m²/g to 30 m²/g measured by the BET method is believed to correlate to particle sizes in the range of about 4 nm to about 100 nm

The surface property of a nanoparticulate can have hydrophilic or hydrophobic characteristic. A hydrophilic nanoparticulate can be hydrophobically modified to have hydrophobic character.

Nano-sized particulates can be of various materials. In addition to being hydrophobic or hydrophobically-modified, the particulate should be insoluble and chemically inert when tested in 28% hydrochloric acid. In a preferred embodiment, the particulate would not dissolve in 35% hydrochloric acid. It should be understood, however, that it is not necessary for the particulate to be insoluble and chemically inert when tested in hydrofluoric (HF) acid.

Nano-sized particulates that are readily commercially available include oxides of silicon, aluminum, antimony, tin, cerium, yttrium and zirconium. The particles are mostly spherical with particles sizes usually ranging from about 4 nm to about 250 nm, but elongated particles, with a length up to 300 nm are also available and believed to be acceptable. The particles may have a negative or positive charge, which electrostatic charges help keep the particles dispersed in a liquid phase. Such oxides are typically hydrophilic, not hydrophobic, however, but it is believed they can be modified to be hydrophobic.

Of these currently commercially available nano-sized particulates of oxides, however, only silicon dioxide is believed to be inert to strong acid. It is contemplated, however, that other metal oxides or metalloid oxides might have the desired properties, including the property of being inert to strong acid. For example, tantalum pentaoxide (Ta₂O₅, also known as tantalum(V) oxide) is contemplated as having the desired properties and being useful according to the invention.

The oxide of silicon is silicon dioxide (SiO₂), which is more commonly known as silica. Silica is the most common material in the Earth's crust, occurring as sandstone or sand. Fumed silica is produced in a flame. For this reason, it is sometimes referred to as pyrogenic silica. It consists of microscopic droplets of amorphous silica fused into branched, chainlike, three-dimensional secondary particles, which then agglomerate into tertiary particles. Fumed silica is made from flame pyrolysis of silicon tetrachloride or from quartz sand vaporized in a 3,000° C. electric arc. Major global producers are Evonik (who sells it under the name AEROSIL™), Cabot Corporation (CAB-O-SIL™), and Wacker Chemie-Dow Corning. Primary particles of fumed silica have a diameter of about 5 nm to about 50 nm.

Precipitated silica is silica produced by precipitation. The production of precipitated silica starts with the reaction of an alkaline silicate solution with a mineral acid. Sulfuric acid and sodium silicate solutions are added simultaneously with agitation to water. Precipitation is carried out under alkaline conditions. The choice of agitation, duration of precipitation, the addition rate of reactants, their temperature and concentration, and pH can vary the properties of the silica. The formation of a gel stage is avoided by stirring at elevated temperatures. The resulting white precipitate is filtered, washed and dried in the manufacturing process. Primary particles of precipitated silica have a diameter of about 5 nm to about 100 nm.

Hydrophobic silica, which is also known as hydrophobically-modified silica, is silica that has hydrophobic groups chemically bonded to the surface. Hydrophobic silica can be made from fumed or precipitated silica. The naturally hydrophilic silica can be made hydrophobic using a chemical agent selected, for example, from a group consisting of organosiloxane, organosilane, fluoro-organosiloxane, fluoro-organosilane, and fluorocarbon. The hydrophobic groups are normally alkyl or polydimethylsiloxane chains. Silica is hydrophilic due to silanol (Si—OH) groups on the surface. These silanol groups may be chemically reacted with various reagents to render the silica hydrophobic. For example, fumed silica can be reacted with chlorosilanes in a fluidized bed reactor at 400° C. Precipitated silica can be hydrophobized with e.g. alkylchlorosilanes or trimethylsilanol in the precipitated solution. The hydrophobized silica is filtered, washed, dried, and tempered to 300° C. to 400° C. to complete the reaction.

Various hydrophobizing agents for nano-particulates are disclosed, for example, in U.S. Pat. No. 5,429,873 entitled “Surface Modified Silicon Dioxides” issued Jul. 4, 1995, U.S. Pat. No. 5,919,298 entitled “Method of Preparing Hydrophobic Fumed Silica” issued Jul. 6, 1999, and U.S. Pat. No. 7,282,236 entitled “Hydrophobic Silica” issued Oct. 16, 1007, which are incorporated by reference in their entirety.

The hydrophobic character can be expressed as carbon content that varies from about 0.1 to about 15% by weight of the particulate, as discussed, for example in U.S. Pat. No. 5,959,005 entitled “Silanized Silica” issued Sep. 28, 1999, and U.S. Pat. No. 5,919,298 entitled “Method of Preparing Hydrophobic Fumed Silica” issued Jul. 6, 1999, which are incorporated herein by reference in their entirety. The carbon content can be found for example, by elemental analysis, e.g., CHN analysis for elemental carbon, hydrogen, and nitrogen content.

According to a preferred embodiment of the invention, the hydrophobic particulate comprises hydrophobically modified silica.

Water Phase with Acid

Preferably, the water for use in the treatment fluid does not contain anything that would adversely interact with the other components used in the well fluid or with the subterranean formation.

The aqueous phase can include freshwater or non-freshwater. Non-freshwater sources of water can include surface water ranging from brackish water to seawater, brine, returned water (sometimes referred to as flowback water) from the delivery of a well fluid into a well, unused well fluid, and produced water. As used herein, brine refers to water having at least 40,000 mg/L total dissolved solids.

In some embodiments, the aqueous phase of the treatment fluid may comprise a brine. The brine chosen should be compatible with the formation and should have a sufficient density to provide the appropriate degree of well control.

Salts may optionally be included in the treatment fluids for many purposes. For example, salts may be added to a water source, for example, to provide a brine, and a resulting treatment fluid, having a desired density. Salts may optionally be included for reasons related to compatibility of the treatment fluid with the formation and formation fluids. To determine whether a salt may be beneficially used for compatibility purposes, a compatibility test may be performed to identify potential compatibility problems. From such tests, one of ordinary skill in the art with the benefit of this disclosure will be able to determine whether a salt should be included in a treatment fluid.

Suitable salts can include, but are not limited to, calcium chloride, sodium chloride, magnesium chloride, potassium chloride, sodium bromide, potassium bromide, ammonium chloride, sodium formate, potassium formate, cesium formate, mixtures thereof, and the like. The amount of salt that should be added should be the amount necessary for formation compatibility, such as stability of clay minerals, taking into consideration the crystallization temperature of the brine, e.g., the temperature at which the salt precipitates from the brine as the temperature drops.

The water includes one or more acids that are sufficiently strong and in a sufficient concentration to cause the water to have a pH of less than zero. For example, at least 5% hydrochloric acid can be used. While other acids can be used, the strong acid preferably comprises hydrochloric acid. For example, sulfuric acid would produce undesirable sulfur dioxide.

In a preferred embodiment, the hydrochloric acid is in a concentration of at least 5% by weight of water of the internal aqueous phase. More preferably, the hydrochloric acid is in a concentration in the range of 24% to 28% by weight of water of the internal aqueous phase.

Emulsion Proportions

According to a preferred embodiment of the invention, the emulsified acid has the following proportions: (a) from about 13 vol % to about 45 vol % of the at least one oil; (b) from about 50 vol % to about 85 vol % of the at least one aqueous acid solution; (c) from about 1 vol % to about 5 vol % of the at least one emulsifier; and (d) from about 0.1 wt % to about 5 wt % of acid insoluble nanoparticles.

Additives

According to a preferred embodiment of the invention, the corrosion inhibitor is selected from the group consisting of: a quaternary ammonium salt, 1-(benzyl)quinolinium chloride, and an aldehyde.

The corrosion inhibitor is preferably in a concentration of at least 0.1% by weight of the emulsion. More preferably, the corrosion inhibitor is in a concentration in the range of 0.1% to 5% by weight of the emulsion.

A corrosion inhibitor intensifier enhances the effectiveness of a corrosion inhibitor over the effectiveness of the corrosion inhibitor without the corrosion inhibitor intensifier. According to a preferred embodiment of the invention, the corrosion inhibitor intensifier is selected from the group consisting of: formic acid and potassium iodide.

The corrosion inhibitor intensifier is preferably in a concentration of at least 0.1% by weight of the emulsion. More preferably, the corrosion inhibitor intensifier is in a concentration in the range of 0.1% to 20% by weight of the emulsion.

The emulsion can also include other additives. For example, the emulsion can contain a freezing-point depressant. Preferably, the freezing point depressant is for the water of the continuous phase. Preferably, the freezing-point depressant is selected from the group consisting of water soluble ionic salts, alcohols, glycols, urea, and any combination thereof in any proportion.

Method

According to a embodiment of the invention, a method of acidizing a treatment zone of a subterranean formation in a well is provided. The method includes the steps of: (A) forming a treatment fluid comprising a composition according to the invention; and (B) introducing the treatment fluid into a well, wherein the design temperature is at least 275° F.

According to a preferred embodiment of the method, the subterranean formation to be treated is a carbonate formation.

The treatment fluid may be prepared at the job site, prepared at a plant or facility prior to use, or certain components of the treatment fluid (e.g., the continuous liquid phase and the viscosity-increasing agent) may be pre-mixed prior to use and then transported to the job site. Certain components of the treatment fluid may be provided as a “dry mix” to be combined with the continuous liquid phase or other components prior to or during introducing the treatment fluid into the subterranean formation. In certain embodiments, the treatment fluid may be placed into the subterranean formation by placing the treatment fluid into a well bore that penetrates a portion of the subterranean formation.

In certain embodiments (e.g., fracturing operations), the treatment fluid may be introduced into the subterranean formation at or above a pressure sufficient to create or enhance one or more fractures in a portion of the subterranean formation. In an embodiment, the step of introducing comprises introducing under conditions for fracturing a treatment zone. The fluid is introduced into the treatment zone at a rate and pressure that are at least sufficient to fracture the zone.

In an embodiment, the step of introducing is at a rate and pressure below the fracture pressure of the treatment zone. In an embodiment, the step of introducing comprises introducing under conditions for gravel packing the treatment zone.

In some embodiments, placing the treatment fluid into the subterranean formation comprises placing the treatment fluid into a well bore penetrating the subterranean formation.

In an embodiment, the treatment fluid is allowed time for spending the acid against the treatment zone, which is also expected to break the emulsion.

In an embodiment, a step of flowing back from the treatment zone is within 24 hours of the step of introducing. In another embodiment, the step of flowing back is within 16 hours of the step of introducing.

Preferably, after any such well treatment, a step of producing hydrocarbon from the subterranean formation is the desirable objective.

### EXAMPLES

To facilitate a better understanding of the present invention, the following examples of certain aspects of some embodiments are given. In no way should the following examples be read to limit, or define, the entire scope of the invention.

It has been a common observation that when an emulsion breaks during a corrosion test, the corrosion loss was high, far above 0.05 lb/ft². This is very simple to explain: since the metal was directly exposed to weakly inhibited acid after the destabilization of emulsion, it was corroded.

While used alone, each component is not an inhibitor itself and hence cannot protect the alloy from corrosion. This would lead to very high corrosion and may create uncertainty about the results: in case the emulsion breaks, whether it is due to very high corrosion loss or due to the presence of that component.

Diesel available in normal fuel stations was used for all the tests. 40 L diesel was obtained and used for all the tests. The emulsifier was mixed with the diesel in a waning blender jar. The aqueous phase was prepared in a beaker separately and added to the diesel phase very slowly with stifling.

Unless specified, a total of 200 ml emulsion with oil-to-aqueous phase ratio of 30:70 (V/V) was prepared for each test in a 500 ml blender jar. Once the addition was completed, the blend was mixed for 4 to 5 minutes keeping the Variac™ transformer at 70 and blender mixing speed at “low”. A total of 6 to 7 minutes were used for the entire mixing starting from addition. Immediately after mixing, the blend was transferred to plastic beakers and the blender jar was washed.

Once the blend was prepared, a few drops of it were poured in water to see if they spread or sink. Sinking without spreading was considered as sign of formation of an invert emulsion. However, it could not be treated as any indication of stability of the emulsion when treated at high temperature. In case the drops spread, the emulsion was discarded and fresh blend was prepared.

Weight loss corrosion tests were performed in individual Hastelloy™ B-2 Autoclaves. Coupons were prepared by degreasing with acetone, bead blasting, washing with water and acetone in sequences. A coupon was set inside glass cell using Teflon hook to suspend it. 100 ml of test blend was poured into the test cell. After capping the cell, the autoclave is filled with EPF S20 oil as heat transfer medium. Care was taken to fill the autoclave just up to 1 inch below the mouth of the glass cell to avoid any mixing of the oil with the emulsion during the test. Then the autoclave was closed and pressurized to the test pressure of 1,000 psi with nitrogen gas. Heating was accomplished using Eurotherm™ controllers, which adjust a specific heat ramp up to test temperature via computer control. Pressure was maintained during the test using a backpressure regulator assembly, which allows for automatic bleed off excess pressure developed during heating and corrosion. Test times are contact time including heat up and cool down time.

The emulsion stability was evaluated by visual observation of the emulsified acid blend kept in a measuring cylinder after test. Any bottom water separation was considerate as destabilization. After the weight loss corrosion tests, the blend was transferred carefully to a glass cylinder and allowed to stay for 5 to 10 minutes so that all bubbles/foams disappear. Then any visual bottom water separation was noted for the tests carried out in the visual cell, the test blend was kept in a measuring cylinder and the cylinder was placed inside the visual cell. The cell was closed and pressurized to 1,000 psi and then heated up to the necessary temperature. Test temperature was reached in 75 minutes and the temperature sensor was sensing the temperature of the heating jacket, which in turn, was heated by four pencil heaters inserted inside it. The heaters are switched off before 0.25 hour of the scheduled test duration and the test cell was cooled down to room temperature using fans. A flash light was used from behind the quartz window to visualize any separation of water at the bottom. Since the emulsion blends were opaque and became darker on heating, it was very difficult to differentiate any change that took place. It required very good observation power to correctly identify the changes, if any. Besides noting the changes during tests, once the test was over, the cell was cooled down, depressurized, and the cylinder was taken out. Appearances of the blends were recorded.

Preferably, the emulsifier is added to oil phase. In addition, the emulsifier is preferably selected for being specific for stabilizing at least an HCl acid internal phase. Cationic amines are preferred.

According to a preferred embodiment, the emulsifier comprises about 50% tallow alkyl amine acetates, C16-C18 (known as CAS 61790-60) in a suitable solvent such as heavy aromatic naphtha and ethylene glycol.

The hydrophobically modified silica can be formed according to the methods described in U.S. Pat. No. 8,110,037, issued Feb. 7, 2012, entitled “Treatments and kits for creating transparent renewable surface protective coatings”; and U.S. Pat. No. 8,034,173 issued Oct. 11, 2011 entitled “Processing compositions and method of forming the same”, each of which is incorporated herein by reference in its entirety. In addition, the following U.S. patents and patent publications regarding hydrophobically modified silica are incorporated by reference: U.S. Pat. No. 8,075,862; 2009/0298982; U.S. Pat. Nos. 7,981,211; 8,163,080; 8,211,971; 7,972,431; 2009/0076198; and 2010/0292079.

In an embodiment, the “hydrophobic modified silica” is “EVONIK-AEROSIL™ R816”, commercially available from Evonik Industries AG. It has a tapped density of particles: 40 gram/liter, Specific surface area (BET) 190±20 m²/kg. It is a silica flour in appearance. AEROSIL™ R 816 is a fumed silica after treated with a hexadecylsilane based on AEROSIL™ 200. AEROSIL™ R 816 has a particle size of less than 20 nm. Other suitable grades of hydrophobic modified silica are commercially available from Evonik Industries AG in Germany. AEROSIL™ hydrophobic fumed silica are produced by chemical treatment of hydrophilic grades with silanes or siloxanes. In the finished product the treatment agent is chemically bonded to the previously hydrophilic oxide. AEROSIL® hydrophobic products are characterized, among other things, by a low moisture adsorption, excellent dispersibility, and their ability to adjust rheological behavior, even that of polar systems. In addition, Evonik offers combinations of hydrophobic silica with other hydrophobic metal oxides (SiO₂, Al₂O₃, or TiO₂). Another source of hydrophobic silica may be Hi-Mar Specialty Chemicals of Milwaukee, Wis.

Examples of corrosion inhibitors include acetylenic alcohols, Mannich condensation products (such as those formed by reacting an aldehyde, a carbonyl containing compound and a nitrogen containing compound), unsaturated carbonyl compounds, unsaturated ether compounds, formamide, formic acid, formates, other sources of carbonyl, iodides, terpenes, and aromatic hydrocarbons, coffee, tobacco, gelatin, cinnamaldehyde, cinnamaldehyde derivatives, acetylenic alcohols, fluorinated surfactants, quaternary derivatives of heterocyclic nitrogen bases, quaternary derivatives of halomethylated aromatic compounds, combinations of such compounds used in conjunction with iodine; quaternary ammonium compounds; and combinations thereof. Suitable corrosion inhibitors and intensifiers are available from Halliburton Energy Services and include: “MSA-II™” corrosion inhibitor, “MSA-III” corrosion inhibitor, “HAI-25 E+” environmentally friendly low temp corrosion inhibitor, “HAI-404™” acid corrosion inhibitor, “HAI-50™” Inhibitor, “HAI-61™” Corrosion inhibitor, “HAI-62™” acid corrosion inhibitor, “HAI-65™” Corrosion inhibitor, “HAI-72E+™” Corrosion inhibitor, “HAI-75™” High temperature acid inhibitor, “HAI-81M™” Acid corrosion inhibitor, “HAI-85™” Acid corrosion inhibitor, “HAI-85M™” Acid corrosion inhibitor, “HAI-202 Environmental Corrosion Inhibitor,” “HAI-OS” Corrosion Inhibitor, “HAI-GE” Corrosion Inhibitor, “FDP-S692-03” Corrosion inhibitor for organic acids, “FDP-S656AM-02” and “FDP-S656BW-02” Environmental Corrosion Inhibitor System, “HII-500” Corrosion inhibitor intensifier, “HII-500M” Corrosion inhibitor intensifier, “HII-124” Acid inhibitor intensifier, “HII-124B” Acid inhibitor intensifier, “HII-124C™” Inhibitor intensifier, and “HII-124F™” corrosion inhibitor intensifier.

HAI-404M™ is a cationic corrosion inhibitor with a quaternary compound. Typical concentrations of HAI-404M™ in the range of about 8 gal/Mgal to about 12 gal/Mgal. HAI-404M™ acid corrosion inhibitor, formerly known as HAI-404™ acid corrosion inhibitor, is a high-performance, cationic acid corrosion inhibitor designed for use in hydrochloric acids (HCl) blends. Alloys N-80, J-55, 13Cr, S13Cr 110, 22Cr and 25Cr can be effectively inhibited with HAI-404M™ inhibitor.

HAI-OS™ is a nonionic HCl corrosion inhibitor. It demonstrates excellent solubility in weighted and un-weighted fluids at room temperature and bottom hole static temperature (BHST). It has been tested in 15% HCl, 28% HCl, Sandstone Completion Acid, and weighted acid blends. Typical concentrations used are in the range of about 8 gal/Mgal to about 16 gal/Mgal.

Formic acid (95% aqueous solution) is a corrosion inhibitor intensifier.

Potassium iodide is another corrosion-inhibitor intensifier, which when used with some reducing agents, helps convert ferric iron to ferrous iron in unspent acid. Potassium iodide intensifier can be used in acid systems containing up to 28% hydrochloric acid (HCl). It is especially effective in combination with formic acid or HII-124C™ intensifiers. Potassium iodide intensifier is effective at bottom hole temperatures (BHTs) up to at least 425° F. (218° C.). Intensifier concentrations typically vary between about 1 lb/Mgal to about 100 lb/Mgal. Potassium iodide intensifier can be used with all acid-corrosion inhibitors. It is not compatible with diazonium salts, oxidants, or bromine. When used with an appropriate reducing agent, it will help decrease corrosion rates, additive separation, sludging, and emulsions caused by ferric iron.

For corrosion testing, a coupon of casing grade metal alloy material (Low alloy carbon steel) was used, specifically “P110” having the following specifications: chemical composition in %: C, 0.26˜0.35, Si: 0.17˜0.37, Mn: 0.4˜0.7, P: ≦0.02, _S≦0.01, Cr: 0.8˜1.1, Ni: ≦0.2, Cu≦0.2, Mo≦0.15˜0.25, V≦0.08, Als≦0.02 and remaining Fe with mechanical properties as: Tensile strength: ≧862 MPa, Yield Strength: 758˜965 MPa.

The tested emulsion compositions are shown in Table 1. The results of the corrosion and stability testing are shown in Table 2.

TABLE 1
Test Emulsions

| | | | | Intensifier | | |
|---|---|---|---|---|---|---|
| | | | Potassium | 95% | | |
| | Inhibitor | Inhibitor | Iodide as | Formic | Emulsifier | Hydrophobic |
| | HAI-404M | HAI-OS | Intensifier | Acid | CAS 61790-60 | silica |
| | GPT of | GPT of | lb/Mgal of | lb/Mgal of | GPT of | lb/Mgal of |
| Emul. # | emulsion | Emulsion | emulsion | emulsion | emulsion | emulsion |
| 1 | 8 | 0 | 0 | 40 | 12 | 0 |
| 2 | 8 | 0 | 0 | 40 | 12 | 30 |
| 3 | 8 | 0 | 30 | 40 | 12 | 60 |
| 4 | 12 | 0 | 0 | 40 | 16 | 20 |
| 5 | 0 | 20 | 30 | 40 | 25 | 0 |
| 6 | 0 | 20 | 0 | 40 | 20 | 22 |
| 7 | 12 | 0 | 0 | 40 | 16 | 40 |
| 8 | 8 | 0 | 120 | 5 | 15 | 40 |

TABLE 2
Stability and Breaking of the Test Emulsions

| | | | | | Sodium |
|---|---|---|---|---|---|
| | | | | | Carbonate |
| | | | | | Static |
| | | | | Emulsion | Break Test |
| | | | Coupon P110 | stability | @ 75° F. |
| | Time | Temp. | Corrosion Loss | at end of | (room |
| Emulsion # | Hours | ° F. | lb/ft² | test | temp) |
| 1 | 4 | 275 | 0.16 | Broken | NA |
| 2 | 4 | 275 | 0.06 | Stable | Yes |
| 3 | 4 | 275 | 0.0657 | Stable | Yes |
| 4 | 4 | 275 | 0.0494 | Stable | Yes |
| 5 | 3 | 275 | 0.1 | Broken | NA |
| 6 | 3 | 275 | 0.0633 | Stable | Yes |
| 7 | 2 | 300 | 0.044 | Stable | Yes |
| 8 | 3 | 325 | No Coupon/ | Stable | Yes |
| | | | only stability | | |
| | | | test | | |
| 9 | 3 | 350 | No Coupon/ | Broken | NA |
| | | | only stability | | |
| | | | test | | |

It was found experimentally that HAI-404M™ is the best inhibitor which can be used at 275° F. up to 3 hour to protect N 80/P-110 alloy in 28% emulsified HCl acid. The time duration could be increased to 4 hour by addition of hydrophobic silica to the oil phase.

The emulsion compositions according to the invention provided better emulsion stability at higher temperatures for longer periods compared to fluids without the hydrophobic particulate, particularly where it is difficult to get stability with the existing emulsified acid system. Even very small quantity of the additive is giving significantly improved performance in terms of emulsion stability and corrosion inhibition compared to a formulation without the hydrophobic fumed silica.

The new system has increased applicability of present 28% HCl emulsified acid system to 4 hour at 275° F. from 3 hour.

The new system has extended the applicability of current Halliburton's 28% HCl emulsified acid system to 300° F. (at least for 2 hour) from 275° F. of the existing system.

The emulsion compositions according to the invention are expected to provide one or more benefits, including without limitation: (a) a relatively high viscosity, which is expected to provide fluid diversion and improved zonal coverage; (b) slower acid spending rate resulting in efficient stimulation of oil well, including, for example, better acid wormholing profiles due to slower acid spending rate; (c) improved corrosion inhibition by coating itself on the metal surface; (d) stabilizing the emulsion in cases where the current emulsified acid systems are unstable for more than 3 hours at high temperatures of 325° F. and above due to incompatibility of the emulsifiers with higher inhibitor concentration required for acid concentrations like 28% HCl acid; (e) significant reduction in corrosion loss due to stable emulsion especially at 275° F. for 4 hours; (f) more efficient oil well stimulations using higher concentration of acid; (g) better stimulation, hence higher production due to slower acid reaction rate; and (h) usefulness in the wells with high design temperatures where existing emulsified acid systems cannot work, thus expanding the application temperature range of the current formulation.

### CONCLUSION

Therefore, the present invention is well adapted to attain the ends and advantages mentioned as well as those that are inherent therein.

The particular embodiments disclosed above are illustrative only, as the present invention may be modified and practiced in different but equivalent manners apparent to those skilled in the art having the benefit of the teachings herein. It is, therefore, evident that the particular illustrative embodiments disclosed above may be altered or modified and all such variations are considered within the scope and spirit of the present invention.

The various elements or steps according to the disclosed elements or steps can be combined advantageously or practiced together in various combinations or sub-combinations of elements or sequences of steps to increase the efficiency and benefits that can be obtained from the invention.

The invention illustratively disclosed herein suitably may be practiced in the absence of any element or step that is not specifically disclosed or claimed.

Furthermore, no limitations are intended to the details of construction, composition, design, or steps herein shown, other than as described in the claims.

What is claimed is:

1. A composition in the form of an emulsion comprising:
(i) a continuous oil phase comprising:
(a) an oil;
(b) an emulsifier; and
(c) a particulate comprising an oxide selected from the group consisting of metal oxides, metalloid oxides, and any combination thereof, wherein the particulate is hydrophobically modified, would not dissolve in oil or 28% hydrochloric acid, and has a surface area in the range of 700 m²/g to 30 m²/g; and
(ii) an internal aqueous phase comprising water having a pH of less than zero.

2. The composition according to claim 1, wherein the oil of the external oil phase comprises an oil selected from the group consisting of petroleum, diesel, or synthetic oil.

3. The composition according to claim 1, wherein the emulsifier is a cationic amine.

4. The composition according to claim 1, wherein the particulate comprises hydrophobically modified silica.

5. The composition according to claim 1, wherein the hydrophobic particulate is in a concentration of at least 0.1% by weight of combined external oil phase and internal aqueous phase.

6. The composition according to claim 1, wherein the internal aqueous phase comprises a strong acid.

7. The composition according to claim 6, wherein the strong acid comprises hydrochloric acid in a concentration of at least 5% by weight of water of the internal aqueous phase.

8. The composition according to claim 6, wherein the strong acid comprises hydrochloric acid in a concentration in the range of 24% to 28% by weight of water of the internal aqueous phase.

9. The composition according to claim 1, additionally comprising a corrosion inhibitor.

10. The composition according to claim 9, additionally comprising a corrosion inhibitor intensifier.

11. A method of acidizing a treatment zone of a subterranean formation in a well, the method comprising the steps of:
(A) forming a treatment fluid in the form of an emulsion, the treatment fluid comprising:
(i) a continuous oil phase comprising:
(a) an oil;
(b) an emulsifier; and
(c) comprising an oxide selected from the group consisting of metal oxides, metalloid oxides, and any combination thereof, wherein the particulate is hydrophobically modified, would not dissolve in oil or 28% hydrochloric acid, and has a surface area in the range of 700 m²/g to 30 m²/g; and
(ii) an internal aqueous phase comprising water having a pH of less than zero; and
(B) introducing the treatment fluid into a well, wherein the design temperature is at least 275° F.

12. The method according to claim 11, wherein the oil of the external oil phase comprises an oil selected from the group consisting of petroleum, diesel, or synthetic oil.

13. The method according to claim 11, wherein the emulsifier is a cationic amine.

14. The method according to claim 11, wherein the particulate comprises hydrophobically modified silica.

15. The method according to claim 11, wherein the particulate is in a concentration of at least 0.1% by weight of combined external oil phase and internal aqueous phase.

16. The method according to claim 11, wherein the internal aqueous phase comprises a strong acid.

17. The method according to claim 16, wherein the strong acid comprises hydrochloric acid in a concentration of at least 5% by weight of water of the internal aqueous phase.

18. The method according to claim 16, wherein the strong acid comprises hydrochloric acid in a concentration in the range of 24% to 28% by weight of water of the internal aqueous phase.

19. The method according to claim 11, additionally comprising a corrosion inhibitor.

20. The method according to claim 19, additionally comprising a corrosion inhibitor intensifier.

21. The method according to claim 10, wherein the subterranean formation is a carbonate formation.
